(19) United States
(12) Patent Application Publication
(10) Pub. No.: US 2003/0151327 A1
(43) Pub. Date: Aug. 14, 2003

(54) Process for forming the stack of metallic laminations for the stator of an eletric motor and the stack of metallic laminations

(76) Inventor: Rivio Arturo Ramirez, Joinville (BR)

Correspondence Address: DARBY & DARBY P.C., P. O. BOX 5257, NEW YORK, NY, 10150-5257, US

(21) Appl. No.: 10/240,616

(22) PCT Filed: Mar. 30, 2001
(86) PCT No.: PCT/BR01/00033

(30) Foreign Application Priority Data
Mar. 30, 2000 (BR) PI 0002188-1

(51) Int. Cl. H02K 1/06

(52) U.S. Cl. 310/217

(57) ABSTRACT

A process for forming the stack of metallic laminations for the stator of an electric motor and the stack of metallic laminations, from a plurality of overlapped metallic laminations (11), which are annular, mutually concentric and each provided with a plurality of orifices (14) axially aligned with respective orifices of the other metallic laminations (11), in order to define axial housings (15) along the height of the lamination stack (10), said process comprising the steps of: a—molding, in each axial housing (15), a respective insert (20) in a non-conductive material, occupying the whole volume of said axial housing (15); and b—hardening each insert (20) molded inside the respective axial housing (15), in order to lock said metallic laminations (10) against rotational and mutually relative displacements parallel and transversal in relation to the longitudinal axis of the lamination stack (10).

### FIELD OF THE INVENTION

The present invention refers to a process for forming the lamination stack for the stator of an electric motor, particularly for the fixation of the metallic laminations of the lamination stack.

### BACKGROUND OF THE INVENTION

The known induction electric motors have a stator comprising a core formed by a stack of metallic laminations in order to lodge the windings of the motor coil.

In order to obtain the lamination stack of the rotor, the metallic laminations of said stack are required to be overlapped onto each other and mutually aligned according to a common central axis, and previously affixed to each other before the lamination stack is mounted around a motor shaft.

Nowadays, the formation of the lamination stack that forms the stator occurs by employing one of the following four techniques: welding, gluing, or clamping the laminations, or by using braces.

In the assembly by welding, which is achieved by using a conventional or laser type weld, the main disadvantage is the loss of electrical efficiency of the stator and consequently of the motor, due to the occurrence of short-circuits of the metallic laminations of the lamination stack (FIG. 1).

In the formation of the lamination stack by gluing the metallic laminations thereof, the disadvantages are low productivity and the long time required for obtaining each piece of the lamination stack. Moreover, this process is known to be unclean, with a high level of toxicity from the gases involved, which may affect the health of the workers.

The technique for forming the lamination stack by clamping the metallic laminations thereof in a press (interlocking system) presents as a main drawback the high cost of the raw material used for stamping the metallic laminations, since this raw material must have an insulating coating for minimizing the occurrence of short-circuits between the overlapped metallic laminations, which short-circuits, when occur, reduce the electrical efficiency of both the stator and the motor (FIG. 3).

In the assembly of the lamination stack of the stator by using a clamp or an external brace, the main disadvantage resides in the fact that it is not possible to avoid the relative displacement between the metallic laminations that form the lamination stack of the stator upon mounting thereof to the motor, generating errors that are transferred to the internal diameter of the stator, resulting in a high rate of re-processing and production of scrap in the assembly line (FIG. 4).

### DISCLOSURE OF THE INVENTION

Thus, it is an object of the present invention to provide a process for forming the stack of metallic laminations for the stator of an electric motor, which allows obtaining and maintaining a correct and aligned pre-fixation between the metallic laminations of said lamination stack, without the disadvantages of the known techniques, allowing, for example, to minimize the displacement between the laminations during the assembly of the lamination stack, and to obtain the metallic laminations of the stack of laminations with a large tolerance.

This and other objectives of the present invention are achieved by a process for forming the stack of metallic laminations for the stator of an electric motor, from a plurality of overlapped metallic laminations, which are annular, mutually concentric and each provided with a plurality of orifices axially aligned with respective orifices of the other metallic laminations, in order to define axial housings along the height of the lamination stack, said process comprising the steps of a—molding, in each axial housing, a respective insert in a non-conductive material, occupying the whole volume of said axial housing; and b—hardening each insert molded inside the respective axial housing, in order to lock said metallic laminations against rotational and mutually relative displacements parallel to and transversal in relation to the longitudinal axis of the lamination stack.

### BRIEF DESCRIPTION OF THE DRAWINGS

The invention will be described below, with reference to the attached drawings, in which:

FIG. 1 is a perspective view of a lamination stack of a rotor, with the laminations affixed to each other by a first process of the prior art, illustrating the weld used in this process;

FIG. 2 is a perspective view of a lamination stack of a rotor, with the laminations affixed to each other by a second process of the prior art (gluing);

FIG. 3 is a perspective view of a lamination stack of a rotor, with the laminations affixed to each other by a third process of the prior art, illustrating the clamps (or rivets) used in this process;

FIG. 4 is a perspective view of a lamination stack of a rotor, with the laminations affixed to each other by a fourth process of the prior art, illustrating the braces used in this process;

FIG. 5 is a perspective view of a lamination stack of a rotor with the laminations affixed to each other according to the present invention;

FIG. 6 is a plan view of the lamination stack of FIG. 5;

FIG. 7 shows, schematically, a longitudinal sectional view of the lamination stack of FIG. 5, taken according to line VII illustrated in FIG. 6; and

FIG. 7a shows, schematically, an enlarged view of the detail illustrated in FIG. 7, illustrating the positioning of the insert of the present invention in the lamination stack.

### BEST MODE OF CARRYING OUT THE INVENTION

The present invention is applied to the formation of a lamination stack 10, which defines the rotor core of an electric motor, said lamination stack 10 being formed by a plurality of overlapped metallic laminations 11, which are annular and mutually concentric, said lamination stack 10 being affixed around an extension of a motor shaft (not illustrated). Each metallic lamination 11 is provided with a central opening 12 to be mounted to the motor shaft and with end orifices 13, angularly equidistant from each other, in order to allow said lamination stack 10 to be attached to the electric motor.

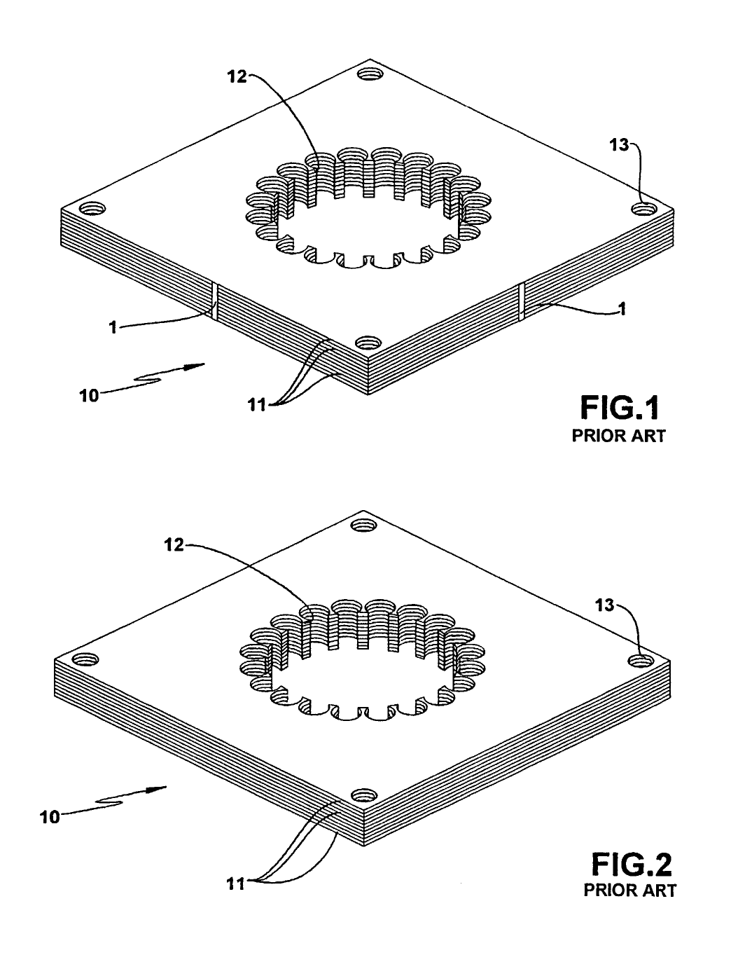

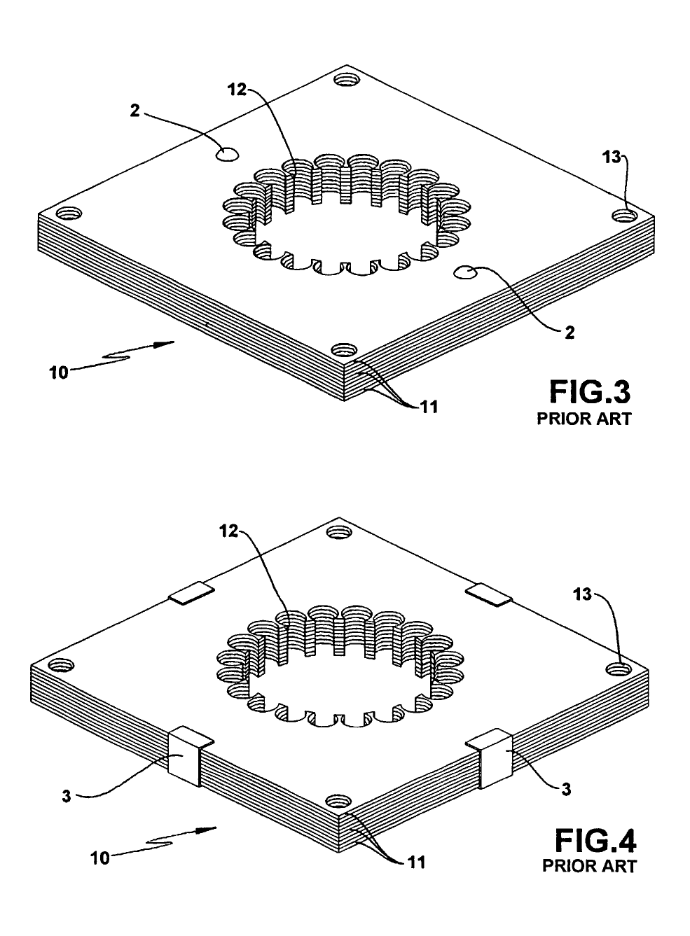

According to the known prior art solutions, the lamination stack 10 is formed by having its metallic laminations 11 affixed to each other by one of the techniques of: gluing (FIG. 2); welding, defining a welding line 1 (FIG. 1); introduction of clamps 2 (or rivets) in orifices previously provided in the metallic laminations 11 of the lamination stack 10 during stamping thereof (FIG. 3); and provision of braces 3 pressing the metallic laminations 11 of the lamination stack 10. These solutions present the deficiencies discussed above.

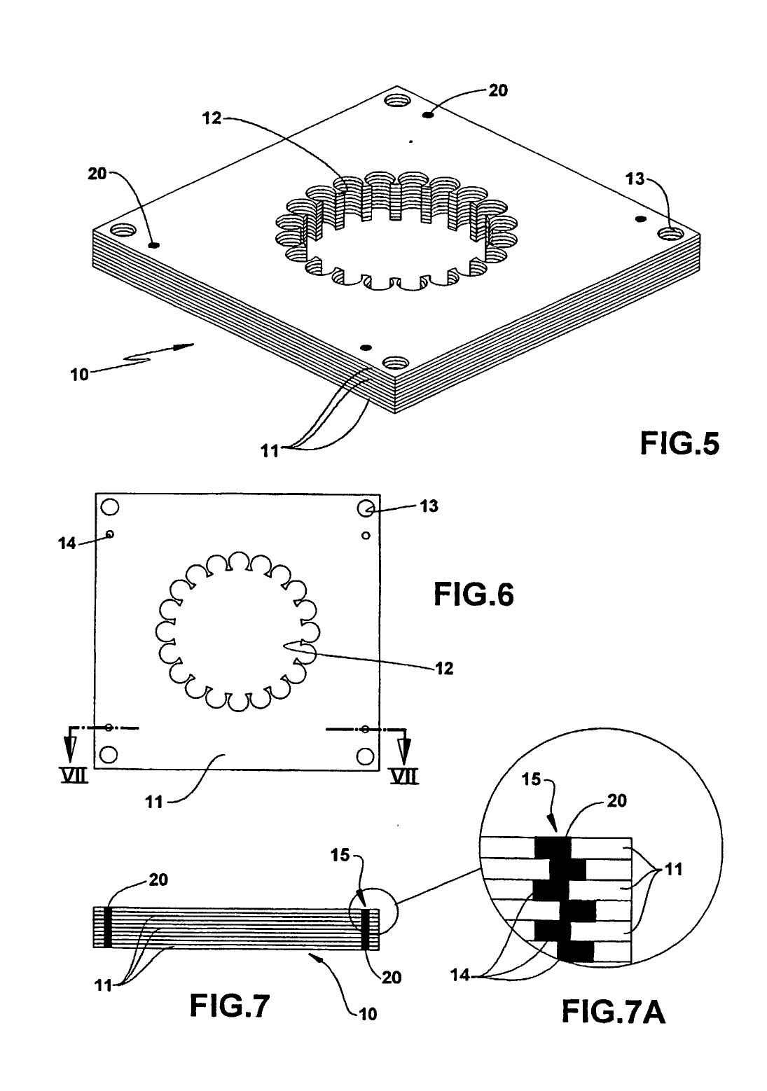

According to the present invention, as illustrated in FIGS. 5-7a, each metallic lamination 11 is further provided with a plurality of orifices 14, which are angularly equidistant from each other and defined, for instance, during stamping of each metallic lamination 11, in a region of the surface thereof between its central opening 12 and the end orifices 13. The overlapping of the metallic laminations 11 that will form the lamination stack 10 occurs in such a way that the orifices 14 of each metallic lamination 11 are aligned with the respective orifices 14 of the other metallic laminations 11 of the lamination stack 10, thus defining along the height of the latter, axial housings 15, for the assembly and fixation of retaining means, to be described below, which assure the maintenance of the alignment and fixation of the metallic laminations 11 of the lamination stack 10.

According to the present invention, after the step of overlapping and aligning the metallic laminations 11 of the lamination stack 10, the process for forming the latter includes the step of molding, in each axial housing 1, a respective insert 20 made of a non-conductive material and occupying the whole volume of said axial housing, as well as the subsequent step of hardening each said insert 20 molded inside the respective axial housing 15, in order to lock the metallic laminations 11 against rotational and mutually relative displacements, which are parallel and transversal in relation to the longitudinal axis of the lamination stack 10.

The inserts 20 define the retaining elements and are provided, for example, by injection and curing, for example by heating a determined amount of thermoset material, such as thermoplastic, inside each axial housing 20.

According to a way of carrying out the present invention, before introducing the inserts 20 in the axial housings 15 of the lamination stack 10 being formed, the latter is heated to a determined maximum temperature, which is calculated to produce curing of the non-conductive material that forms the inserts 20, as they are being injected in each axial housing 15.

When hardened, each insert 20 maintains the shape of the axial housing 15 into which it has been injected, occupying the whole cavity thereof (FIG. 7a) and thus avoiding relative movements between the metallic laminations 11, guaranteeing the relative positioning of alignment of the latter in the formation of the lamination stack 10. Using the insert in a non-conductive material avoids the occurrence of short circuits between the metallic laminations 11 of the lamination stack 10 and the consequent loss of efficiency in the stator. Moreover, this process allows to reduce the time for producing the lamination stack and is carried out in a clean way, causing no harm to the health of the persons working in the production line.

1. A process for forming the stack of metallic laminations for the stator of a linear motor, from a plurality of overlapped metallic laminations (11), which are annular, mutually concentric and each provided with a plurality of orifices (14) axially aligned with respective orifices of the other metallic laminations (11), in order to define axial housings (15) along the height of the lamination stack (10), said process being characterized in that it comprises the steps of: a—molding, in each axial housing (15); a respective insert (20) in a non-conductive material, occupying the whole volume of said axial housing (15); b—heating the lamination stack (10) to a determined minimum temperature for producing the cure of the non-conductive material of the inserts (20); and c—hardening each insert (20) molded inside the respective axial housing (15), in order to lock said metallic laminations (10) against rotational and mutually relative displacements parallel and transversal in relation to the longitudinal axis of the lamination stack (10).

2. Process, according to claim 1, characterized in that the heating of the lamination stack (10) of step “b” is maintained upon introduction of the latter in each axial housing (15).

3. Process, according to claim 1, characterized in that, in step “a”, the non-conductive material is injected in each axial housing (15).

4. Process, according to claim 3, characterized in that, in step “a”, the injected non-conductive material is a thermoset material.

5. Process, according to claim 4, characterized in that, in step “a”, the injected non-conductive material is a plastic material.

6. A stack of metallic laminations, for the stator of an electric motor, formed from a plurality of overlapped metallic laminations (11), which are annular, mutually concentric and each provided with a plurality of orifices (14) axially aligned with respective orifices of the other metallic laminations (11), in order to define axial housings (15) along the height of the lamination stack (10), characterized in that each axial housing (15) has its volume totally occupied by an insert (20) of a non-conductive material, which is molded and hardened in order to lock said metallic laminations (11) against rotational and mutually relative displacements parallel and transversal in relation to the longitudinal axis of the lamination stack (10).
